(19) United States
(12) Patent Application Publication
(10) Pub. No.: US 2017/0086005 A1
(43) Pub. Date: Mar. 23, 2017

(54) SYSTEM AND METHOD FOR PROCESSING AUDIO SIGNAL

(71) Applicant: INTELLECTUAL DISCOVERY CO., LTD., Seoul (KR)

(72) Inventors: Hyun Oh OH, Gwacheon-si (KR); Tae Gyu LEE, Seongnam-si (KR); Jin Sam KWAK, Uiwang-si (KR); Ju Hyung SON, Uiwang-si (KR)

(73) Assignee: INTELLECTUAL DISCOVERY CO., LTD., Seoul (KR)

(21) Appl. No.: 15/125,407

(22) PCT Filed: Jan. 19, 2015
(86) PCT No.: PCT/KR2015/000505

§ 371 Date: Sep. 12, 2016

(30) Foreign Application Priority Data
Mar. 25, 2014 (KR) 10-2014-0034592
Mar. 25, 2014 (KR) 10-2014-0034594

(51) Int. Cl. H04S 7/00; H04S 3/00; H04R 5/02

(52) U.S. Cl. CPC H04S 7/301; H04R 5/02; H04S 3/008; H04S 7/308; H04S 2420/01; H04S 2400/03; H04S 2400/01; H04S 2400/11

(57) ABSTRACT

The present invention for a method for processing an audio signal comprises the steps of: receiving a channel signal; receiving an input of location information for a plurality of previously configured speakers; configuring the location of a target speaker from among the locations of member speakers; placing a virtual speaker at the location of a member speaker on the same layer as the target speaker on the basis of location information for the previously configured speakers; rendering a channel signal corresponding to the location of the target speaker on the basis of the placed virtual speaker; and down-mixing the rendered channel signal with the channel signal corresponding to the previously configured speaker, wherein the channel signal comprises the channel signal corresponding to a member speaker.

### TECHNICAL FIELD

The present invention relates to an apparatus and method for processing audio signals.

### BACKGROUND ART

3D audio is realized by providing a sound scene (2D) on a horizontal plane, which existing surround audio has provided, with another axis (dimension) in the direction of height. 3D audio literally refers to various techniques for providing sound with presence in 3-dimensional space, such as signal processing, transmission, encoding, reproduction techniques, and the like. Specifically, in order to provide 3D audio, a greater number of speakers is used than in the conventional technology, or alternatively, rendering technology is required which forms sound images at virtual locations at which speakers are not present, even if a small number of speakers is used.

3D audio is expected to be the audio solution for Ultra-High Definition Television (UHD TV), which is to be launched soon, and is expected to be variously used for sound in vehicles, which are evolving into spaces for providing high-quality infotainment, as well as sound for theaters, personal 3D TVs, tablets, smart phones, cloud games, and the like.

In 3D audio, it is necessary to transmit signals having up to 22.2 channels, which is higher than the number of channels in the conventional art, and to this end, an appropriate compression and transmission technique is required. Conventional high-quality encoding techniques, such as MP3, AAC, DTS, AC3, etc., are optimized to transmit signals having 5.1 or fewer channels.

Also, in order to reproduce a 22.2-channel signal, an infrastructure for a listening room in which a 24-speaker system is installed is required. However, because it is not easy to construct such an infrastructure for a listening room in which a 24-speaker system is installed, various rendering techniques are required. Specifically, required are downmix rendering for effectively reproducing 22.2-channel signals in a space in which the number of speakers that are installed is lower than the number of channels, upmix rendering for reproducing an existing stereo or 5.1-channel sound source in a 10.1- or 22.2-channel environment, in which the number of speakers that are installed is higher than the number of channels, flexible rendering, which enables the provision of a sound scene offered by an original sound source in a space in which a provided speaker arrangement and a provided listening environment differ from designated ones, a technique that enables enjoying 3D sound in listening environments such as headphones, and the like.

Meanwhile, as an alternative for effectively transmitting a sound scene, an object-based signal transmission method is required. Depending on the sound source, transmission based on objects may be more advantageous than transmission based on channels, and in the case of transmission based on objects, interactive listening to a sound source becomes possible, for example, a user may freely control the reproduced size and position of an object. Accordingly, an effective transmission method that enables an object signal to be compressed so as to be transmitted at a high transmission rate is required.

Also, there may be a sound source in which a channel-based signal and an object-based signal are mixed, and through such a sound source, a new listening experience may be provided. Therefore, a technique for effectively transmitting both the channel-based signal and the object-based signal at the same time is necessary, and a technique for effectively rendering the signals is also required.

Additionally, there may be exceptional channels, the signals of which are difficult to reproduce using existing methods due to the distinct characteristics of the channels and the speaker environment in the reproduction environment. In this case, a technique for effectively reproducing the signals of the exceptional channels based on the speaker environment at the reproduction stage is required.

Meanwhile, sound sources reproduced through audio signals may include not only sound sources that include only channel-based signals or only object-based signals but also sound sources in which channel-based signals and object-based signals are mixed, and such sound sources may provide users with a new listening experience.

However, the current MPEG-H 3D audio, in which individual renderers are respectively provided for channel-based signals and object-based signals, may have a problem caused by the difference between the performance of the channel renderer and that of the object renderer. In other words, distortion may occur due to the performance difference, whereby the sound scene may not be reproduced as intended.

In this regard, Korean Patent Application Publication No. 2011-0082553, titled “Binaural rendering of a multi-channel audio signal”, discloses a technique for reducing the number of decorrelations or synthetic signal processing steps compared to separately decorrelating each stereo downmix channel.

Also, Korean Patent Application Publication No. 2011-0002504, titled “Enhanced coding and parameter representation of multi-channel downmixed object coding”, discloses a technique for creating downmix information by distributing multiple audio objects into at least two downmix channels and creating an encoded audio object signal by creating object parameters.

### DISCLOSURE

### Technical Problem

Accordingly, the present invention is made keeping in mind the above problems occurring in the conventional art, and some embodiments of the present invention provide an audio signal processing method for effectively reproducing sound sources depending on the characteristics thereof by arranging a virtual speaker in the position of an absent channel and rendering a channel signal corresponding thereto when there is no channel located in an exceptional position or when there is no channel having an exceptional function.

Also, some embodiments of the present invention provide a system and method for processing audio signals, which create information about the range within which installed speakers are capable of reproducing sound sources and which reproduce the sound sources using the installed speakers through rendering when there is no channel located in an exceptional position or when there is no channel having an exceptional function.

Meanwhile, the technical problems to be solved in the present embodiment are not limited to the above-mentioned technical problems, and there may be other technical problems.

### Technical Solution

As a technical solution for accomplishing the above objects, a method for processing an audio signal according to the first aspect of the present invention includes receiving a channel signal, receiving information about positions of multiple speakers that are installed, setting a position of a target speaker, selected from among positions of absent speakers, arranging a virtual speaker at a position of an absent speaker in a layer in which the target speaker is located based on the information about the positions of the installed multiple speakers, rendering a channel signal corresponding to the position of the target speaker based on the arranged virtual speaker, and downmixing the rendered channel signal to a channel signal corresponding to the installed speaker, wherein the channel signal includes a channel signal corresponding to an absent speaker.

Also, an apparatus for processing an audio signal according to the second aspect of the present invention includes a position information receiving unit for receiving information about positions of multiple speakers that are installed, an audio bitstream receiving unit for receiving an audio bitstream that includes a channel signal and an object signal, a reproductable range information generation unit for generating a reproduction range within which the multiple speakers are capable of reproducing a sound source based on the information about the positions of the multiple speakers, an exceptional object signal determining unit for determining whether the object signal corresponds to an exceptional object that is not included in the reproduction range, and a rendering unit for rendering the object signal based on a result of the determining.

Also, a method for processing an audio signal performed in an audio signal processing apparatus according to the third aspect of the present invention includes generating information about a reproduction range within which multiple speakers that are installed are capable of reproducing a sound source based on information about positions of the multiple speakers, determining whether a received object signal is an exceptional object signal that is not included in the reproduction range, and rendering the object signal based on a result of the determining. Here, the rendering the object signal includes, if the object signal is determined to be an exceptional object signal, generating multiple virtual speakers in a layer in which an exceptional object, corresponding to the exceptional object signal, is located based on each of the multiple speakers, and rendering the exceptional object signal based on a result of comparison of a predetermined threshold value with a number of objects accumulated when the objects are reproduced through the multiple virtual speakers.

### Advantageous Effects

According to the above-mentioned technical solutions of the present invention, when a speaker corresponding to an exceptional channel is absent on a reproduction stage, sound sources may be effectively reproduced using other speakers.

Also, when there is an exceptional object that falls outside of the range within which sound sources can be reproduced by installed speakers, an object signal corresponding to the exceptional object is rendered, whereby the exceptional object signal may be reproduced using the installed speakers.

### DESCRIPTION OF DRAWINGS

FIG. 1 is a view for describing a viewing angle depending on a display size at the same viewing distance;

FIG. 2 is a view illustrating 22.2-channel speaker placement as an example of a multi-channel audio environment;

FIG. 3 is a concept diagram that shows the positions of sound objects that form a 3-dimensional sound scene in a listening room;

FIG. 4 is a view illustrating the overall structure of a 3D audio decoder and renderer, which include a channel renderer or an object renderer;

FIG. 5 is a view illustrating an example in which 5.1 channels are arranged at positions according to the recommendation of ITU-R and at arbitrary positions.

FIG. 6 is a view illustrating a structure in which an object signal decoder is combined with a flexible speaker rendering unit;

FIG. 7 is a block diagram of an audio signal processing apparatus according to an embodiment of the present invention;

FIG. 8 is a flowchart of an audio signal processing method according to an embodiment of the present invention;

FIGS. 9 and 10 are views illustrating a method for rendering an exceptional channel signal;

FIG. 11 is a block diagram of an audio signal processing system according to another embodiment of the present invention;

FIGS. 12 and 13 are views illustrating a method for rendering an exceptional object according to another embodiment of the present invention;

FIG. 14 is a flowchart of an audio signal processing method according to another embodiment of the present invention; and

FIG. 15 is a view illustrating an example of an apparatus in which an audio signal processing method according to the present invention is implemented.

### BEST MODE

Hereinafter, exemplary embodiments will be described in detail with reference to the accompanying drawings so that the inventive concept may be readily implemented by those skilled in the art. However, it is to be noted that the present disclosure is not limited to the exemplary embodiments, but can be realized in various other ways. In the drawings, certain parts not directly relevant to the description are omitted to enhance the clarity of the drawings, and like reference numerals denote like parts throughout the whole document.

Throughout the document, when an element is referred to as being “connected” to another element, it can be “directly connected” to the other element or “electrically connected” to the other element while intervening elements may be present therebetween. It will be understood that the terms “comprises” and/or “comprising” or “includes” and/or “including”, when used in this specification, specify the presence of stated elements, but do not preclude the presence or addition of one or more other elements. Throughout the document, the term “step of” does not mean “step for”.

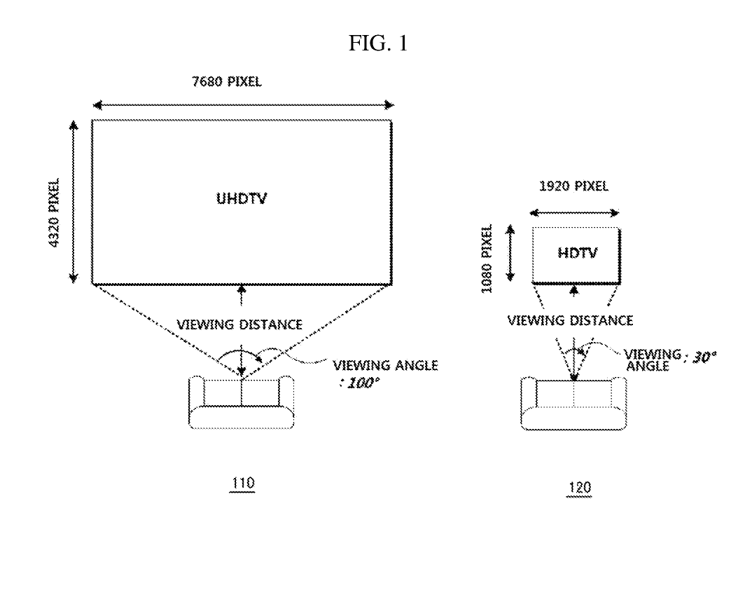

First, an environment in which an audio signal processing apparatus and an audio signal processing method according to the present invention may be implemented is described with reference to FIGS. 1 to 6.

FIG. 1 is a view for describing a viewing angle depending on a display size (for example, UHD TV and HD TV) at the same viewing distance.

Recently, with the development of display manufacturing technology, display sizes are increasing in response to consumers' demands. As shown in FIG. 1, a UHD TV 110 (7680*4320 pixels display) has a display that is 16 times larger than an HD TV 120 (1920*1080 pixels display). When an HD TV 120 is installed on the wall of a living room and a viewer sits on a couch at a constant distance from the TV, the viewing angle may be about 30°. Meanwhile, when a UHD TV 110 is installed at the same distance, the viewing angle amounts to about 100°.

When such a high-resolution high-definition large screen is installed, it is desirable to provide sound with realism and presence as befits the large-scale content. One or two surround channel speakers may not be sufficient to provide an environment that enables viewers to feel as if they were in the scene. Therefore, a multi-channel audio environment having more speakers and more channels is required.

As examples of the above-mentioned environment that requires a multi-channel audio environment, there are not only a home-theater environment but also a personal 3D TV, a smart phone TV, a 22.2-channel audio program, a vehicle, a 3D video, a telepresence room, a cloud-based game, and the like.

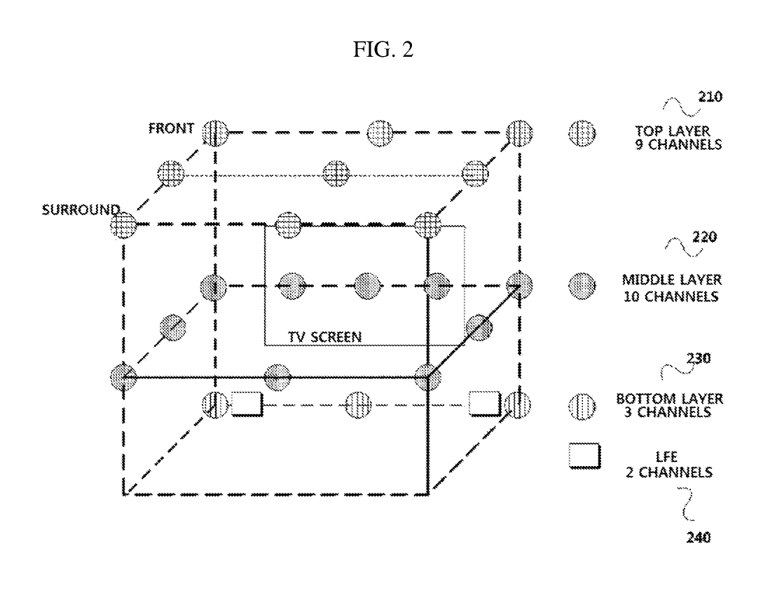

FIG. 2 is a view illustrating 22.2-channel speaker placement as an example of a multi-channel audio environment.

Here, 22.2 channels is merely an example of a multi-channel audio environment for improving sound staging, and the present invention is not limited to a specific number of channels or to a specific speaker arrangement. Referring to FIG. 2, a total of nine channels may be arranged on a top layer 210. Specifically, nine speakers are arranged in such a way that three speakers are arranged at the front, three speakers are arranged at the center position, and three speakers are arranged at the surround position. In the middle layer 220, a total of ten speakers are arranged in such a way that five speakers are arranged at the front, two speakers are arranged at the center position, and three speakers are arranged at the surround position. In the bottom layer 230, three speakers are arranged at the front and two LFE channels 240 are installed.

As described above, in order to transmit and reproduce multi-channel signals, which may range up to dozens of channels, a high computational load is incurred. Also, a high compression rate may be required in consideration of the communication environment. Furthermore, many households have 2-channel or 5.1-channel speaker setups, rather than a multi-channel speaker environment such as a 22.2-channel environment. Therefore, if signals that are commonly transmitted to all users are signals obtained by encoding multi-channel signals, the multi-channel signals may be reproduced after being converted into 2-channel or 5.1-channel signals, and as a result, communication inefficiency may result. Also, because 22.2-channel PCM signals must be stored, it may be inefficient in terms of memory management.

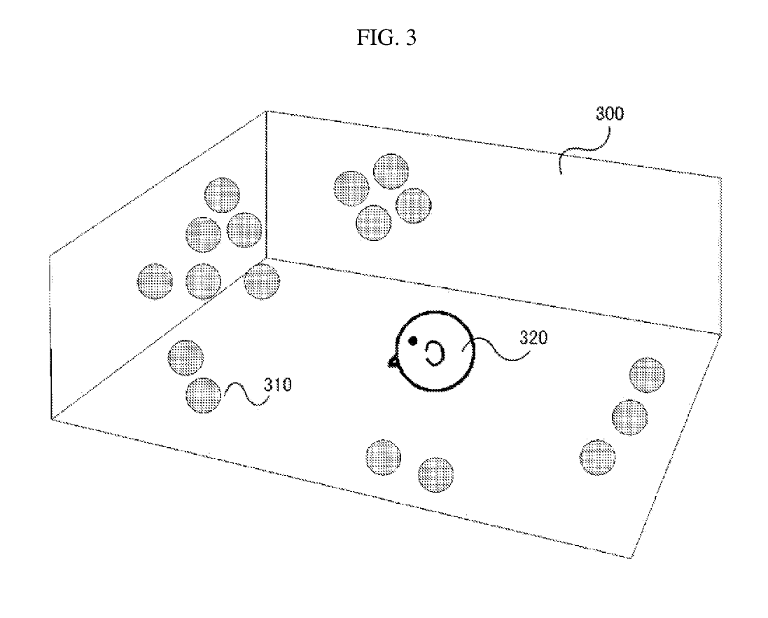

FIG. 3 is a concept diagram that shows the positions of sound objects that form a 3-dimensional sound scene in a listening room.

In a listening room 300 in which a listener 320 listens to 3D audio, respective sound objects 310 that form a 3-dimensional sound scene may be distributed in various positions in the form of point sources 310, as illustrated in FIG. 3.

Meanwhile, each of the objects is depicted as a point source 310 for the convenience of illustration in FIG. 3, but there may be a sound source in the form of a plane wave or an ambient sound source, which is distributed in all the directions in order to enable the awareness of space in a sound scene, besides the point source 310.

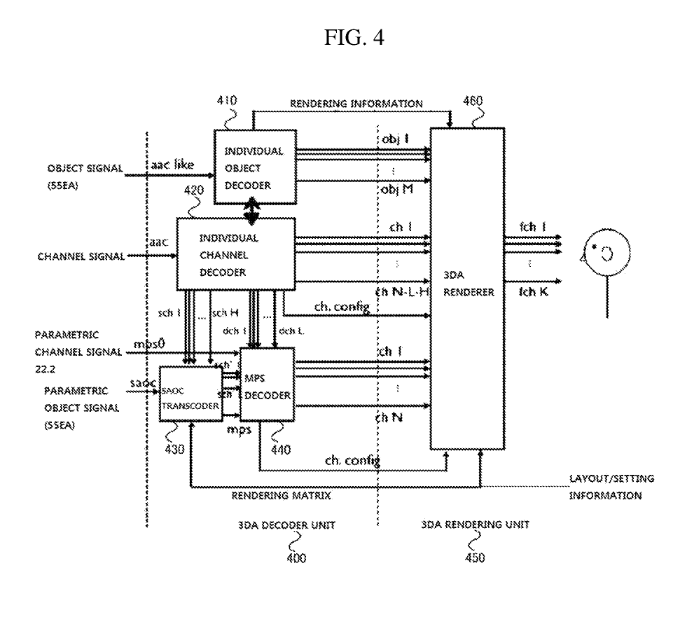

FIG. 4 is a view illustrating the overall structure of a 3D audio decoder and renderer, which include a channel renderer or an object renderer.

The decoder system illustrated in FIG. 4 is largely divided into a 3D audio decoder unit 400 and a 3D audio rendering unit 450.

The 3D audio decoder unit 400 may include an individual object decoder 410, an individual channel decoder 420, an SAOC transducer 430 and an MPS decoder 440.

The individual object decoder 410 receives an object signal, and the individual channel decoder 420 receives a channel signal. Here, an audio bitstream may include only an object signal, only a channel signal, or both an object signal and a channel signal.

Also, the 3D audio decoder unit 400 may receive an object signal or a channel signal, which is waveform-encoded or parametrically encoded, via the SAOC transducer 430 and the MPS decoder 440.

The 3D audio rendering unit 450 includes a 3DA renderer 460, and may render a channel signal, an object signal, or a parametrically encoded signal using the 3DA render 460.

Here, the object signal, the channel signal, or a signal in which an object signal and a channel signal are combined, output from the 3D audio decoder unit 400, is input, and sound is output so as to correspond to the speaker environment in the listening room in which the listener is located. Here, weighted values for the 3D audio decoder unit 440 and the 3D audio rendering unit 450 may be set based on information about the number and positions of speakers in the listening room where the listener is located.

Meanwhile, among techniques necessary for 3D audio, flexible rendering is an important task to be solved in order to improve the quality of 3D audio to the highest level. The reason why flexible rendering is necessary is as follows.

It is well known that 5.1-channel speakers are often atypically placed according to the structure of a living room and the furniture layout. The speakers should be able to provide the sound scene that is intended by the content producer even when the speakers are atypically placed. To this end, differences in the speaker environment based on a user's reproduction environment must be grasped, and a rendering technique for performing calibration to compensate for the difference between the user speaker environment and the speaker arrangement according to a standard specification is required. In other words, a codec should provide not only the decoding of a transmitted bitstream by a decoding method but also a series of techniques for converting the bitstream so as to optimize it for the user's reproduction environment.

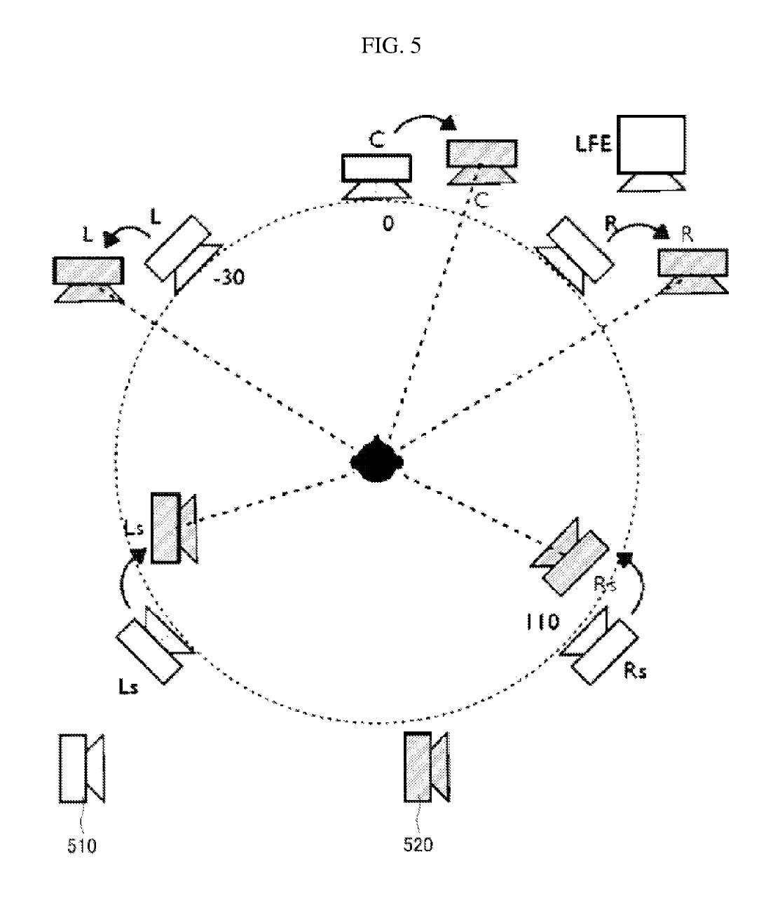

FIG. 5 is a view illustrating an example in which 5.1 channels are arranged at positions according to the recommendation of ITU-R and at arbitrary positions.

The speakers 520, arranged in the actual living room, have different azimuths and different distances from the speakers 510 arranged according to the recommendation of ITU-R. In other words, because the height and orientation of the speakers are different from those of the speakers 510 arranged according to the recommendation, if the signal is reproduced without change through the speakers 520 located at positions different from those in the recommendation, it is difficult to provide an ideal 3D sound scene.

In this situation, if amplitude panning, which determines the direction of a sound source between two speakers based on the amplitude of a signal, or Vector-Based Amplitude Panning (VBAP), which is widely used for determining the direction of a sound source using three speakers in 3-dimensional space, is used, flexible rendering may be conveniently implemented for an object signal, which is transmitted on an object basis. Therefore, in the case of an environment in which speaker placement is changed, transmitting an object signal is advantageous in that a 3D sound scene is more easily provided than when transmitting a channel signal.

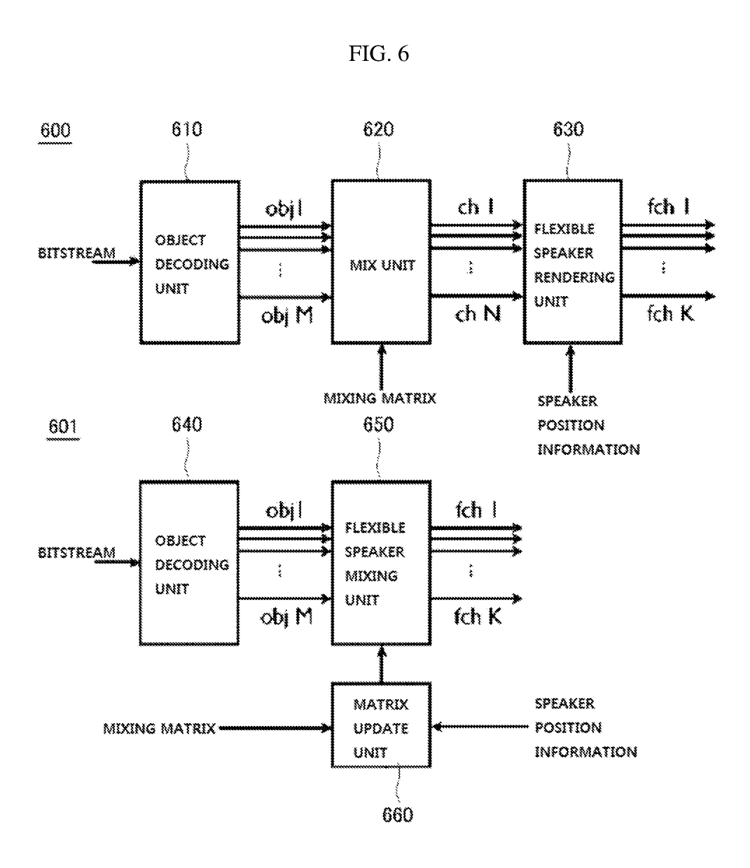

FIG. 6 is a view illustrating a structure in which an object signal decoder is combined with a flexible speaker rendering unit.

As described with reference to FIG. 5, when an object signal is used, there is an advantage in that the object may be placed in a sound source according to a desired sound scene. A first embodiment 600 and a second embodiment 601, in which the object signal decoder and a flexible speaker rendering unit are combined, and in which the above-mentioned advantage is incorporated, are described.

In the first embodiment 600, in which the object signal decoder is combined with the flexible speaker rendering unit, a mix unit 620 receives object signals from an object decoder unit 610, receives position information in the form of a mixing matrix, and outputs channel signals. That is, position information in a sound scene is represented as information about positions relative to the speakers corresponding to the output channels.

The output channel signals are flexibly rendered by a flexible speaker rendering unit 630 and are then output. Here, if the number and positions of the actual speakers are not identical to the designated number and positions, flexible rendering may be performed by receiving information about the positions of the actual speakers.

Unlike the above example, in the second embodiment 601, after an object decoder unit 640 receives an audio bitstream and decodes object signals, a flexible speaker mixing unit 640 receives the object signals and performs flexible rendering. Here, a matrix update unit 660 delivers a mixing matrix and a matrix that contains information about the speaker positions to the flexible speaker mixing unit 650, whereby the matrices may be applied to flexible rendering.

Rendering a channel signal into another type of channel signal, as in the first embodiment 600, is more difficult than rendering an object directly to a final channel, as in the second embodiment 601. This will be specifically described below.

When a channel signal is transmitted and input, if the position of a speaker for the corresponding channel is changed to an arbitrary position, it is difficult to use a panning method, which is mainly used for an object signal, and thus an additional channel mapping process is required. Additionally, because the process and solution that are necessary for rendering object signals differ from those for rendering channel signals, when both object signals and channel signals are transmitted together and a sound scene in which the two kinds of signals are mixed is reproduced, distortion, caused by spatial discordance, may occur.

In order to solve this problem, flexible rendering on an object is not separately performed, but mixing to a channel signal is performed first and flexible rendering is then performed on the channel signal. Also, it is desirable that rendering using a Head-Related Transfer Function (HRTF) be implemented using the same method.

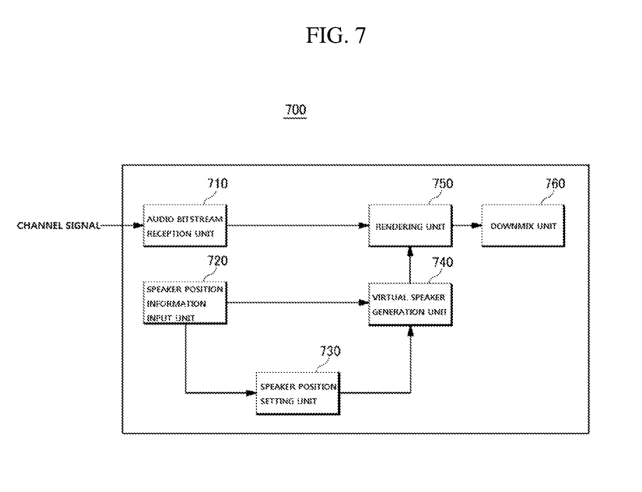

Hereinafter, an audio signal processing method according to the present invention is specifically described with reference to FIGS. 7 to 10.

FIG. 7 is a block diagram of an audio signal processing apparatus 700 to which an audio signal processing method is applied according to an embodiment of the present invention.

An audio signal processing apparatus 700 according to an embodiment of the present invention includes an audio bitstream receiving unit 710, a speaker position information input unit 720, a speaker position setting unit 730, a virtual speaker generation unit 740, a rendering unit 750, and a downmix unit 760.

The audio bitstream receiving unit 710 receives an audio bitstream. Here, the audio bitstream includes a channel signal, and the channel signal may include a channel signal corresponding to an absent speaker. Here, the channel signal may be a 22.2-channel signal.

The speaker position information input unit 720 receives information about the positions of the installed speakers, and the speaker position setting unit 730 sets the position of a target speaker, selected from among the positions of the absent speakers.

Based on the information about the positions of the installed speakers, the virtual speaker generation unit 740 generates a virtual speaker and arranges the virtual speaker at the position of the absent speaker in the layer in which the target speaker is arranged.

The rendering unit 750 renders the channel signal corresponding to the position of the target speaker based on the arranged virtual speaker, and the downmix unit 760 downmixes the rendered channel signal to the channel signal corresponding to the installed speaker.

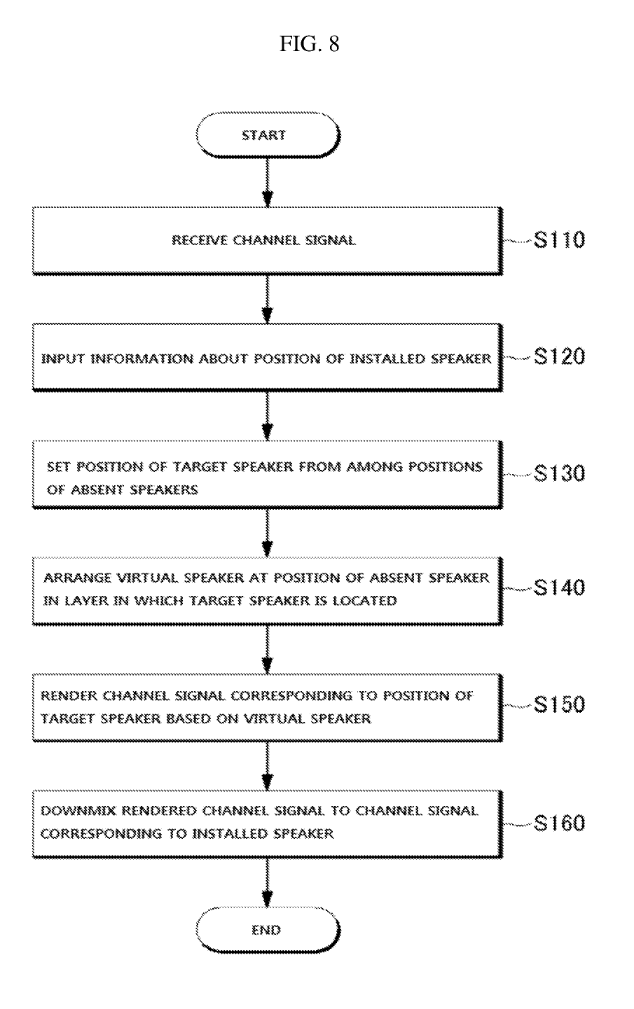

Hereinafter, an audio signal processing method performed in the audio signal processing apparatus 700 is specifically described with reference to FIG. 8.

FIG. 8 is a flowchart of an audio signal processing method according to an embodiment of the present invention.

In an audio signal processing method according to the present invention, first, an audio bitstream that includes a channel signal is received at step S110. Here, the channel signal includes a channel signal corresponding to an absent speaker, and may be a 22-2 channel signal.

Then, information about the positions of multiple speakers, which are already installed, is received at step S120, and the position of a target speaker among the absent speakers is set at step S130.

Then, based on the information about the positions of the installed speakers, a virtual speaker is arranged at the position of the absent speaker in the layer in which the target speaker is arranged at step S140. Here, the virtual speaker may be arranged at the position of the absent speaker located on a vertical line on which the installed speaker is located. For example, if the absent speaker exists in the top layer, the virtual speaker may be arranged at the position of the absent speaker in the top layer such that the speaker positioned in the middle layer and the absent speaker in the top layer are on the same vertical line. Here, one or more virtual speakers may be arranged at each of the positions of the absent speakers.

Then, a channel signal corresponding to the position of the target speaker is rendered at step S150 based on the arranged virtual speaker. Here, based on the virtual speaker and the speaker, which is installed in the layer in which the target speaker is arranged, the channel signal corresponding to the position of the target speaker may be rendered. For example, when two speakers are installed in the top layer and two virtual speakers are arranged, the channel signal corresponding to the target speaker may be rendered to the four speakers.

Next, the rendered channel signal is downmixed to the channel signal corresponding to the installed speakers at step S160. Here, the rendered channel signal may be combined with the channel signal assigned to the speaker installed in the layer in which the target speaker is arranged. Here, the channel signal assigned to the speaker installed in the layer in which the target speaker is arranged is combined with the rendered channel signal, whereby the installed speaker may output the channel signal corresponding to the exceptional channel signal.

Also, the rendered channel signal may be downmixed based on a previously stored Head-Related Transfer Function (HRTF). Here, an individual HRTF, corresponding to a different data set for an individual user, may be used, and downmixing may be performed differently for each azimuth depending on the used HRTF.

Meanwhile, when the position of the target speaker is determined, the target speaker may be arranged in the top layer, among the layers in which speakers are installed. For example, when a 22.2-channel signal is input, if not all speakers corresponding to all 22.2 channels are installed and if a speaker is absent at the center position in the top layer, the target speaker may be arranged at the position of the absent speaker at the center position in the top layer.

Here, a virtual speaker may be arranged at the position of the absent speaker in the top layer such that the virtual speaker and the speaker that are already installed in the middle layer are on the same vertical line. Accordingly, based on the virtual speaker and the speaker installed in the top layer, the channel signal corresponding to the position of the target speaker may be rendered.

Also, the rendered channel signal is combined with the channel signal of the speaker installed in the top layer, and the rendered channel signal corresponding to the virtual speaker may be downmixed to the channel signal corresponding to the speaker installed in the middle layer, wherein the installed speaker is located on the vertical line on which the virtual speaker is located.

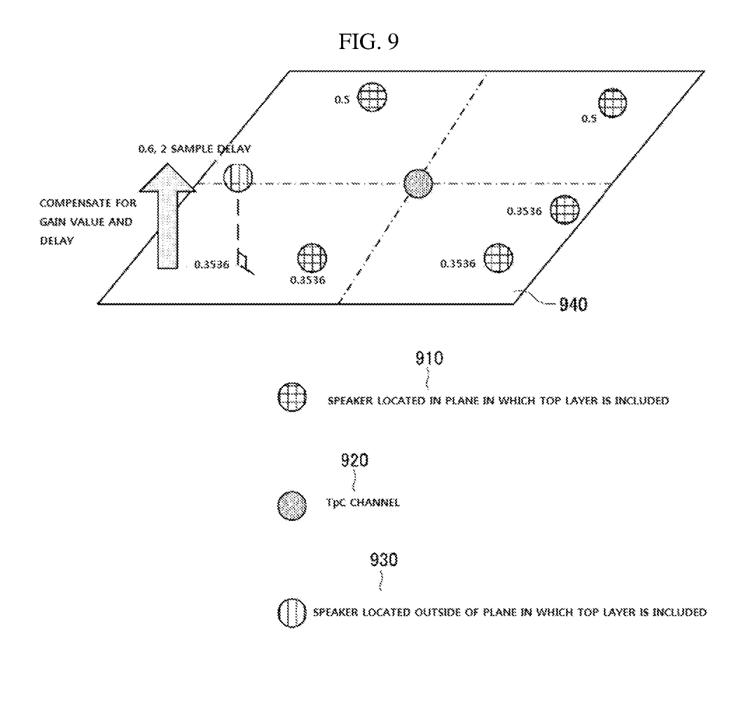

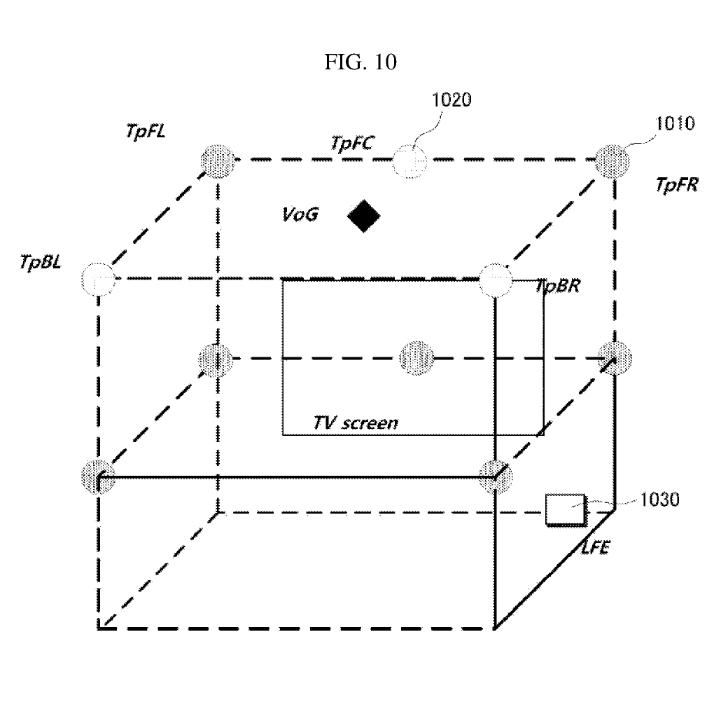

Hereinafter, a method for rendering an exceptional channel signal according to an embodiment of the present invention is specifically described with reference to FIG. 9 and FIG. 10.

FIG. 9 and FIG. 10 are views illustrating a method for rendering an exceptional channel signal.

In a multi-channel audio system, TpC (Top Center), which is the channel located above a listener's head, is called the ‘Voice of God’. The reason why this channel is called the ‘Voice of God’ is that the use of this channel may generate a very dramatic effect, as if a voice were heard from the sky. The TpC channel is an important channel in various scenes, for example, a situation in which something drops from directly overhead, a situation in which firecrackers are set off overhead, a situation in which someone shouts from the roof of a tall building, and a scene in which an airplane comes from the front, passes above the viewer's head, and moves to the rear. That is, the use of a TpC channel may provide a user with a vivid sound field, which cannot be supported by existing audio systems, in many dramatic scenes.

However, in the case of an exceptional channel such as a TpC channel, if there is no speaker at the corresponding position, the use of an existing flexible rendering method does not effectively compensate for such a situation. Therefore, a method for effectively outputting the exceptional channel using a small number of output channels is necessary.

Meanwhile, in order to reproduce multi-channel content through output channels, the number of which is less than the number of channels in the content, a method based on an M-N downmix matrix (where M is the number of input channels and N is the number of output channels) is generally implemented. In other words, when reproducing 5.1-channel content in stereo, the 5.1 channel content is downmixed using a given formula. Such a downmixing method may be performed such that relative downmix gain is applied to speakers in spatial proximity and the results are synthesized.

For example, referring to FIG. 2, the TpFc channel in the top layer may be downmixed to Fc (or FRc, FLc) in the middle layer and may then be synthesized. Namely, a virtual TpFC is generated using these speakers (Fc, FRc, and FLc), whereby the sound corresponding to the position of the absent speaker (TpFc) may be reproduced.

However, in the case of a TpC channel speaker, because the positions of front, back, left, and right relative to TpC are uncertain based on the position of a listener, it is difficult to determine the positions of speakers that are spatially close to TpC, among the speakers arranged in the middle layer. Also, when downmix rendering is performed on signals that are assigned to the TpC channel speaker in an atypical speaker arrangement environment, it may be effective to flexibly change the downmix matrix in connection with a flexible rendering technique.

Accordingly, if a sound source reproduced through the TpC channel speaker is an object corresponding to VoG and it is an object that can only be reproduced through the TpC channel speaker or an object reproduced based on the TpC channel speaker, it is desirable to downmix the object according to the situation. However, if the sound source to be reproduced is a part of an object reproduced in the entire top layer, or when the sound source to be reproduced comes from the position of TpFL, passes through TpC, and goes to TpBR, for example, to convey the moment in which an airplane passes by in the sky, it is desirable to use a downmixing method specialized for such a situation.

Furthermore, when only a limited number of speakers can be used depending on the positions of the speakers, it is necessary to consider a rendering method for locating a sound source at various angles.

Meanwhile, if there are elevation spectral cues, which enable a person to recognize sound source elevation, the sound scene of a TpC channel may be effectively realized by intentionally inserting such elevation spectral cues.

The process of downmixing the signal of an exceptional channel such as a TpC channel is described below with reference to FIG. 9.

An exceptional channel signal may be downmixed by analyzing the specific value of a transmitted bitstream or the characteristics of the signal. As an embodiment of an exceptional channel signal, there is the signal of a TpC channel, which is located above a listener's head. When an exceptional channel signal is stationary at the position above the head or the exceptional channel signal is an ambient signal having ambiguous directionality, the same downmix gain may be applied to multiple channels. In this case, the TpC channel signal may be downmixed using an existing matrix-based downmixer.

However, when a TpC channel signal in a sound scene that is in motion is downmixed using the above-mentioned matrix-based downmixer, the sound scene, which the content provider intended to be dynamic, becomes static. In order to prevent this problem, downmixing having a variable gain value may be performed by analyzing channel signals.

Also, when a desired effect cannot be achieved using only nearby speakers, a spectral cue that enables a person to recognize sound source elevation may be used in the output signals of specific N speakers.

The method to be used may be selected from among the above three downmixing methods by using input bitstream information or by analyzing input channel signals. According to the selected downmixing method, L, M, or N output signals are selected as channel signals.

Meanwhile, the localization of a sound image in a median plane is different from that in a horizontal plane. In order to represent inaccuracy in the localization of the sound image as a numerical value, localization blur may be used, and it represents the range in which the location of the sound image is not distinguishable at a specific position as an angle.

Generally, a voice signal in a median plane has an inaccuracy falling within the range from 9° to 17°, but a voice signal in a horizontal plane has an inaccuracy from 0.9° to 1.5°. That is, it is confirmed that the localization of a sound image in a median plane has very low accuracy. In other words, because, in the case of a sound image having a high elevation, positional accuracy as perceived by a person is low, downmixing using a matrix is more effective than a sophisticated localization method. Therefore, in the case of a sound image the position of which is not greatly changed, the same gain value is distributed to the channels in the top layer, in which speakers are symmetrically arranged, whereby the absent TpC channel may be effectively upmixed to multiple channels.

When the channels in the top layer in the channel environment at the reproduction stage are the same as those of the configuration in FIG. 2 excluding a TpC channel, the channel gain values distributed to the top layer have the same value. However, as is known, it is uncommon to have a typical environment at the reproduction stage, as shown in FIG. 2. Accordingly, when the same gain value is distributed to all the channels in an atypical channel environment, the angle between the sound image and the position intended by the content may be larger than the value of localization blur. This makes a user perceive the sound image incorrectly. In order to prevent this problem, a process for compensating for the atypical channel environment is necessary.

Because a channel that is located in the top layer arrives at the position of a listener in the form of a plane wave, the existing downmixing method, in which a uniform gain value is set, realizes the plane wave, which is generated in a TpC channel, using nearby channels. That is, in the plane including the top layer, the center of gravity of a polygon of which the vertexes correspond to the positions of speakers is consistent with the position of the TpC channel. Therefore, the gain value for each of the channels in the atypical channel environment may be obtained using an equation in which the center of gravity of the 2-dimensional position vectors in the plane including the top layer is consistent with the position vector of the position of the TpC channel, wherein the top layer includes channels in which the gain value is weighted.

However, an approach using this equation requires a high computational load, and there is little difference in performance compared to the simplified method that will be described below. The simplified method is as follows. First, an area is divided into N equiangular areas based on a TpC channel 820. The same gain value is assigned to the equiangular areas, and if two or more speakers are located within the area, the sum of the squares of gain that will be assigned to the speakers is set to be the same as the above-mentioned gain value. That is, suppose a speaker arrangement in which there is a speaker 810 located in a plane including the top layer, a TpC channel speaker 820, and a speaker 830 located outside of the plane including the top layer. Here, when an area is divided into four equiangular areas of 90° each based on the TpC channel 820, a gain value is assigned to the areas so as to make the sum of the squares of the gain value become 1.

In this case, because there are four areas, the gain value for each area is 0.5. When two or more speakers exist within a single area, a gain value is set to make the sum of the squares of the gain value be the same as the gain value for the area. Therefore, the gain value for the outputs of two speakers in the lower right area 840 is 0.3536. Finally, in the case of the speaker 830 located outside of the plane including the top layer, a gain value when the speaker is projected onto the plane including the top layer is calculated, and then the difference in distance between the speaker and the plane is compensated for using the gain value and delay.

Next, a method for rendering an exceptional channel such as VoG is specifically described with reference to FIG. 10.

FIG. 10 shows the 7.1-speaker layout. In this layout, when a channel signal that includes VoG is input, panning the VoG channel signal to the TpFL and TpFR in the top layer, in which speakers 910 are installed, is performed according to the existing rendering method. In this case, the sound that must be provided above a listener's head is generated at the front in the top layer.

In order to solve this problem, the present invention may additionally arrange a virtual speaker 920. In the speaker layout shown in FIG. 10, when a speaker corresponding to the azimuth of the speaker installed in the middle layer is absent in the top layer, a virtual speaker 920 is arranged at the corresponding position. Accordingly, in the example of FIG. 10, virtual speakers 920 are arranged at TpFC, TpBL, and TpBR. Then, rendering may be performed using the five channel speakers in the top layer, which include the two installed speakers 910 and three virtual speakers 920.

Here, a method in which the same weighted value is distributed to all of the speakers in the top layer, or a method in which a weighted value is applied for each area in the top layer may be used as a rendering method as described above.

When a signal is distributed to each speaker in the top layer, if an installed speaker 910 is present, a rendered signal is added to the existing channel signal assigned to the installed speaker 910 and then the signal is reproduced. Here, the channel signal corresponding to the virtual speaker 920 is downmixed to the speaker in the middle layer, which corresponds to the azimuth of the virtual speaker.

Here, downmixing (or Top-to-Middle downmixing) may be implemented using simple addition in the time axis, but may more desirably be implemented as filtering using auditory characteristics. Alternatively, it may be implemented using a parameter, which is generated through a generalized Head-Related Transfer Function or a provided personalized Head-Related Transfer Function.

In the case of a generalized method, a parameter is determined in advance, and the parameter may be information about the frequency and amplitude of a notch or a peak in a specific spectrum or the inter-aural level difference and the inter-aural phase difference at a specific frequency. Therefore, when the domain of a current signal is in a Quadrature Mirror Filter (QMF) domain, filtering may be implemented as QMF domain filtering.

As an embodiment for this, the VoG signal that is finally reproduced in the speaker at the center position in the middle layer is calculated as a weighted value for each frequency band, which is proportional to

$$\frac{{C}_{VoG} \times \frac{1}{sqrt ( K )} \times cgain \times {H}_{{middle}_{0}}}{{H}_{{top}_{0}}} .$$

Here, C_{VoG} denotes the original signal of a VoG channel, K denotes the number of speakers in the middle layer, cgain denotes a weighted value for compensating for the layout inconsistency in the middle layer, H_{(middle}_{₀}₎ denotes a Head-Related Transfer Function corresponding to the channel signal of the speaker located at the front center in the middle layer, and H₍ₜₒₚ_{₀}₎ denotes a Head-Related Transfer Function corresponding to the channel signal of the speaker located at the front center in the top layer.

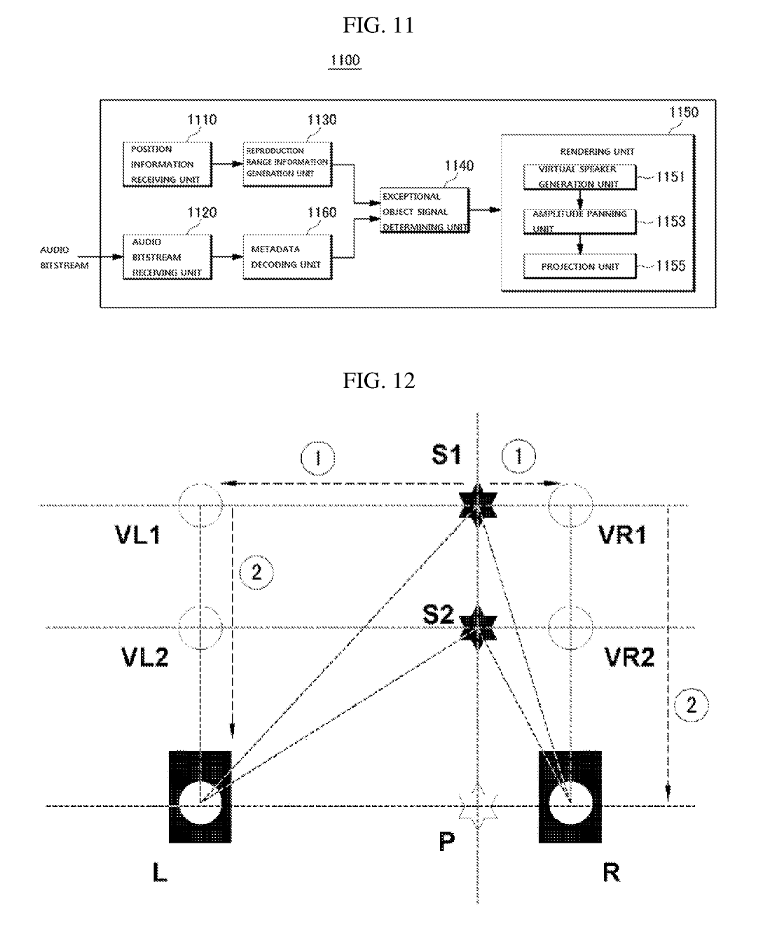

Meanwhile, an apparatus and method for processing an audio signal according to another embodiment of the present invention may render an exceptional object signal corresponding to an exceptional object that falls outside of the range within which a sound source can be reproduced by speakers, and this will be described with reference to FIGS. 11 to 14.

FIG. 11 is a block diagram of an audio signal processing apparatus 1100 according to another embodiment of the present invention.

An audio signal processing apparatus 1100 according to the present invention includes a position information receiving unit 1110, an audio bitstream receiving unit 1120, a reproduction range information generation unit 1130, an exceptional object signal determining unit 1140, and a rendering unit 1150.

The position information receiving unit 1110 receives information about the positions of multiple speakers. Here, the speakers may not be arranged according to the installation regulations, in which case a user may directly input information about the positions of the speakers using a User Interface (UI), or may input the information by selecting one from among a given set. Also, the information about the speaker positions may be input through various methods, such as a long-distance localization technique.

The audio bitstream receiving unit 1120 receives an audio bitstream that includes a channel signal and an object signal. Here, the object signal may include information about the position of an object. The exceptional object signal determining unit 1140 determines whether the object is an exceptional object, which is located outside of the range within which a sound source can be reproduced, by comparing the information about the position of the object with the range within which a sound source can be reproduced, as will be described later.

The reproduction range information generation unit 1130 generates information about the range within which a sound source can be reproduced by speakers based on the information about the speaker positions received by the position information receiving unit 1110. Generally, the range within which a sound source can be reproduced by speakers may be formed by a line connecting the speakers based on Vector Based Amplitude Panning (VBAP), which is a method for selecting three speakers capable of forming the smallest triangle that contains the positions at which the sound sources are intended to be localized.

Generally, the range within which a sound source can be reproduced by speakers may be a range that includes limited positions in a 360° plane from side to side at the height of the user's ear level in the case of a 5.1-channel speaker setup. Meanwhile, when the speaker arrangement may closely localize the sound source at all positions around a user, the range in which a sound source can be reproduced by speakers may have the maximum range.

The exceptional object signal determining unit 1140 determines whether an object signal corresponds to an exceptional object that falls outside of the range within which a sound source can be reproduced by speakers.

The rendering unit 1150 renders an object signal based on the determination of whether the object signal corresponds to an exceptional object. Here, when object signals are determined not to correspond to an exceptional object, the rendering unit 1150 may render object signals corresponding to an object that falls within the range within which a sound source can be reproduced by speakers using a general rendering method. In other words, the rendering unit 150 may render the object signals based on the information about the positions of the multiple speakers.

Conversely, when an object corresponding to the object signal is determined to be an exceptional object, which is not included in the range within which a sound source can be reproduced by speakers, the rendering unit 150 performs rendering using a method that differs from the existing rendering method.

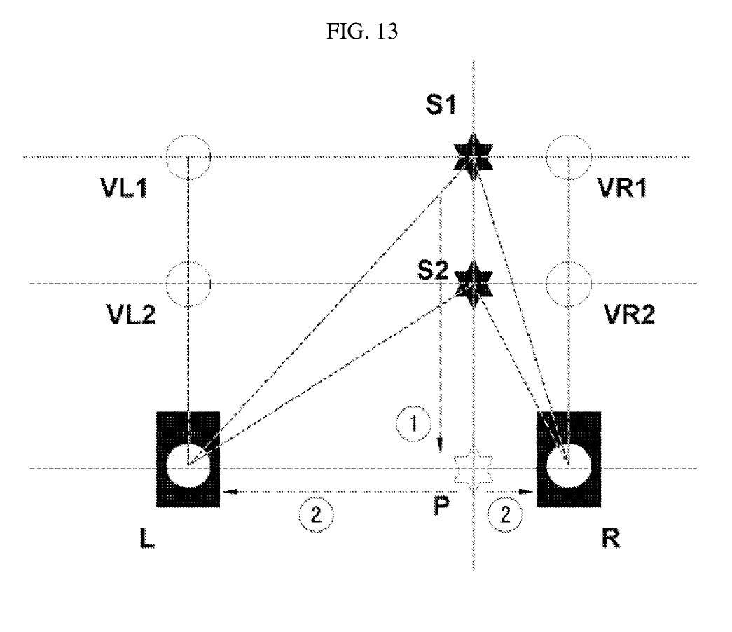

Hereinafter, a first embodiment and a second embodiment of the method for rendering an exceptional object according to another embodiment of the present invention will be described with reference to FIG. 12 and FIG. 13.

FIG. 12 is a view illustrating a method for rendering an exceptional object according to a first embodiment of the present invention.

The rendering unit 1150 according to another embodiment of the present invention may include a virtual speaker generation unit 1151, an amplitude panning unit 1153, and a projection unit 1155.

Based on each of multiple speakers, the virtual speaker generation unit 1151 may generate multiple virtual speakers at a height that is the same as that of an exceptional object. For example, in order to reproduce an object signal for an exceptional object ‘S1’ through the left speaker L and the right speaker R, which are actual speakers, multiple virtual speakers having a height that is the same as that of the exceptional object ‘S1’ may be generated. Here, the virtual speakers are located on the same vertical lines on which the left speaker and the right speaker, which are actual speakers, are respectively located. If there are three actual speakers, virtual speakers may be generated in a plane that is parallel to the plane formed by the three actual speakers.

The amplitude panning unit 1153 may perform amplitude panning of the exceptional object signal to each of the multiple virtual speakers. As shown in FIG. 12, the exceptional object ‘S1’ may be amplitude-panned to the left and right virtual speakers, which correspond to the left and right actual speakers.

The projection unit 1155 may project the exceptional object signal, which is amplitude-panned, onto each of the multiple speakers. In other words, the exceptional object signal, which is amplitude panned to the virtual speaker, is projected onto the actual speaker located on the vertical line on which the virtual speaker is located. Here, because the azimuth when an object signal in the virtual speaker ‘VL1’ is projected onto the actual speaker differs from the azimuth when an object signal in the virtual speaker ‘VL2’ is projected onto the actual speaker, the filters applied to the respective cases may differ from each other.

Meanwhile, the number of objects reproduced through the virtual speaker generation unit 1151 is counted, and if the counted number is equal to or greater than a predetermined threshold value, rendering may be performed using a rendering method according to the first embodiment. In other words, when the number of exceptional objects corresponding to a virtual speaker is large, rendering using a virtual speaker is advantageous in consideration of computational load and interference with nearby objects. Therefore, if the number of exceptional objects is equal to or greater than the threshold value, rendering may be performed using the rendering method according to the first embodiment. However, even if the number of exceptional objects corresponding to a virtual speaker is equal to or greater than the threshold value, rendering is not necessarily performed according to the first embodiment, but may be performed according to a second embodiment, which will be described below.

FIG. 13 is a view illustrating a method for rendering an exceptional object according to a second embodiment of the present invention.

Unlike FIG. 12, the rendering unit 1150 according to another embodiment of the present invention may include a projection unit 1155 and an amplitude panning unit 1153.

The projection unit 1155 may project an exceptional object onto a plane in which multiple speakers are located. In other words, the exceptional object ‘S1’ is projected onto the position ‘P’ in the plane in which the multiple speakers are located, whereby the exceptional object is placed within the range within which a sound source can be reproduced by the speakers.

The amplitude panning unit 1153 may perform amplitude panning of an exceptional object signal, corresponding to an exceptional object, to each of the multiple speakers. That is, the exceptional object signal for the exceptional object located at ‘P’ may be amplitude-panned to the left speaker L and the right speaker R, which are actual speakers.

Meanwhile, the rendering unit 1150 according to the second embodiment may further include a virtual speaker generation unit 1151. The virtual speaker generation unit 1151 may generate multiple virtual speakers at a height that is the same as that of the exceptional object based on each of the multiple speakers. If the number of objects accumulated when the objects are reproduced through the virtual speaker generation unit 1151 is less than a predetermined threshold value, rendering may be performed using an exceptional object rendering method according to the second embodiment.

However, as described with reference to FIG. 12, even if the number of exceptional objects corresponding to the virtual speaker is less than the threshold value, rendering is not necessarily performed according to the second embodiment, but rendering may be performed according to the first embodiment.

When an object is an exceptional object as illustrated in FIG. 12 and FIG. 13, the rendering unit 1150 according to the present invention may render the exceptional object according to the two embodiments in consideration of computational load.

Additionally, when speakers are located in the same plane and exceptional objects ‘S1’ and ‘S2’ are located at different heights as illustrated in FIG. 12 and FIG. 13, the existing rendering method may not distinguish ‘S1’ from ‘S2’. In other words, when the exceptional objects are reproduced by the actual speakers L and R, sound is provided without an elevation cue, as it is provided by the object located at ‘P’. However, the rendering unit 1150 according to an embodiment of the present invention may recognize the vertical positions of objects through a rendering process when exceptional objects are located at different vertical positions, and thus the actual speaker may correctly reproduce the sound.

Meanwhile, the rendering method applied to an audio signal processing apparatus 1100 according to another embodiment of the present invention may be used when an exceptional speaker is present. That is, the position of the exceptional speaker is supposed to be ‘S1’ or ‘S2’ and rendering using a given actual speaker may be performed using the same method.

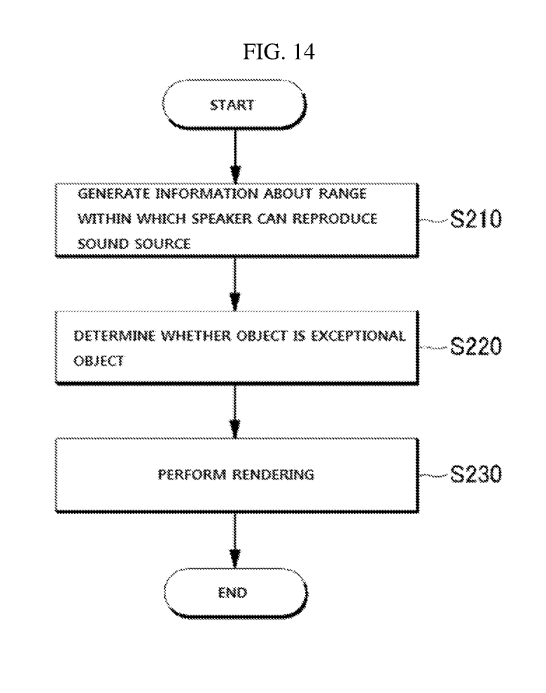

Hereinafter, an audio signal processing method performed in the audio signal processing apparatus 1100 is specifically described with reference to FIG. 14.

FIG. 14 is a flowchart of an audio signal processing method according to another embodiment of the present invention.

In an audio signal processing method performed in the audio signal processing apparatus 1100 according to another embodiment of the present invention, first, information about the range within which a sound source can be reproduced by speakers is generated at step S210 based on information about the positions of the speakers. Because the information about the range within which a sound source can be reproduced is described with reference to FIG. 11, a detailed description will be omitted.

Then, it is determined at step S220 whether an object signal is an exceptional object signal, which is not included in the range within which a sound source can be reproduced, and the object signal is rendered at step S230 based on the result of the determination. Here, rendering the object signal may be performed through a process in which, when the object signal is determined to be an exceptional object signal, multiple virtual speakers having a height that is the same as that of the exceptional object are generated based on each of multiple speakers. Then, the number of objects accumulated when the objects are reproduced by the multiple virtual speakers is compared with a predetermined threshold value, and the exceptional object signal is rendered based on the result of the comparison.

Here, if the number of objects accumulated in the virtual speakers is equal to or greater than the threshold value, amplitude panning of the exceptional object signal to each of the multiple virtual speakers is performed, and the exceptional object signal, which is amplitude-panned, may be projected onto each of the multiple speakers.

Conversely, if the number of objects accumulated in the virtual speakers is less than the threshold value, the exceptional object is projected onto a plane in which the multiple speakers are located, and sound is reproduced by amplitude-panning the exceptional object signal, which corresponds to the projected exceptional object, to each of the multiple speakers.

In other words, when the number of objects accumulated in the virtual speakers is equal to or greater than the threshold value, the exceptional object is rendered using a virtual speaker due to the high computational load. Conversely, when the number of objects accumulated in the virtual speakers is less than the threshold value, the exceptional object is projected and sound is reproduced using amplitude panning.

However, even if the number of exceptional objects corresponding to the virtual speaker is equal to or greater than the threshold value, the exceptional object is not necessarily rendered through the process of amplitude panning the object to a virtual speaker and projecting the object, but may be rendered without using a virtual speaker. Also, even if the number of exceptional objects corresponding to a virtual speaker is less than the threshold value, rendering using a virtual speaker may be performed.

Meanwhile, when it is determined that the object signal is not an exceptional object signal, that is, when the object falls within the range within which a sound source can be reproduced by speakers, rendering may be performed using an existing rendering method. Here, object signals may be rendered based on information about the positions of the multiple speakers.

Additionally, in an audio signal processing method in the audio signal processing apparatus 1100 according to another embodiment of the present invention, information about the positions of multiple speakers may be acquired. Here, the speakers may be arranged at arbitrary positions rather than designated positions. In this case, a user may input the information about the positions of the speakers using a UI, or may input the information by selecting one from among a given set. Alternatively, the position information may be acquired using a speaker position detection module installed in the audio signal processing apparatus 1100. In the speaker position detection module, for example, a localization method using an infrared sensor or an ultrasonic sensor, installed in each speaker, or a position detection method using a camera may be used.

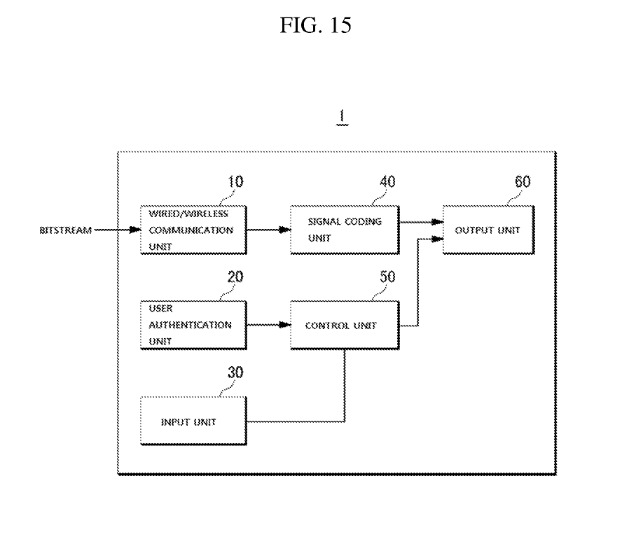

Also, receiving an audio bitstream that includes a channel signal and an object signal may be further included. Here, the received object signal may include information about the object position. Based on the position information, whether the object is included in the range within which a sound source can be reproduced by speakers may be determined. Meanwhile, the apparatus and method for processing an audio signal according to the present invention, which are described with reference to FIGS. 1 to 14, may be implemented by the audio reproduction apparatus 1 illustrated in FIG. 15, which will be described hereinafter.

FIG. 15 is a view illustrating an example of an apparatus in which the audio signal processing method according to the present invention is implemented.

An audio reproduction apparatus 1 according to the present invention may include a wired/wireless communication unit 10, a user authentication unit 20, an input unit 30, a signal coding unit 40, a control unit 50, and an output unit 60.

The wired/wireless communication unit 10 receives an audio bitstream through a wired/wireless communication method. The wired/wireless communication unit 10 may include components such as an infrared communication unit, a Bluetooth unit, and a wireless LAN communication unit, and may receive an audio bitstream using various communication methods.

The user authentication unit 20 receives information about a user and authenticates the user. Here, the user authentication unit 20 may include one or more of a fingerprint recognition unit, an iris recognition unit, a face recognition unit, and a voice recognition unit. In other words, fingerprints, iris information, information about the contour of a face, and voice information are received and converted into user information, and whether the user information matches previously registered user information is determined, whereby user authentication may be performed.

The input unit 30 is an input device for enabling a user to input various kinds of instructions, and may include one or more of a keypad unit, a touchpad unit, and a remote control unit.

The signal coding unit 40 encodes or decodes an audio signal, a video signal, or a combination thereof, received by the wired/wireless communication unit 10, and may output an audio signal in the time domain. The signal coding unit 40 may include an audio signal processing apparatus, and the audio signal processing method according to the present invention may be applied to the audio signal processing apparatus.

The control unit 50 receives an input signal from the input devices and controls all of the processes of the signal encoding unit 40 and the output unit 60. The output unit 60 outputs an output signal generated by the signal coding unit 40, and may include components such as a speaker unit and a display unit. Here, if the output signal is an audio signal, the output signal may be output through a speaker, and if the output signal is a video signal, the output signal may be output through a display.

For reference, the components according to an embodiment of the present invention, which are illustrated in FIG. 4, FIGS. 6 to 9, FIG. 11, and FIG. 15, may be software or hardware components such as a Field Programmable Gate Array (FPGA) or an Application Specific Integrated Circuit (ASIC), and may perform predetermined functions.

However, the components are not limited to software or hardware, and each of the components may be stored in an addressable storage medium or may be configured to be implemented using one or more processors.

Accordingly, the components may include, for example, components such as software components, object-oriented software components, class components, and task components, and processes, functions, attributes, procedures, subroutines, segments of program code, drivers, firmware, microcode, circuits, data, database, data structures, tables, arrays, and variables.

The components and functions thereof can be combined with each other so as to form a smaller number of components or can be divided into additional components.

Meanwhile, an embodiment of the present invention may be implemented as a recording medium that includes instructions executable by a computer such as a program module executed by a computer. A computer-readable medium may be any usable medium that can be accessed by a computer and may include all volatile and nonvolatile media and detachable and non-detachable media. Also, the computer-readable medium may include all computer storage media and communication media. The computer storage medium includes all volatile and nonvolatile media and detachable and non-detachable media implemented by a certain method or technology for storing information such as computer-readable instructions, data structures, program modules, or other data. The communication medium typically includes computer-readable instructions, data structures, program modules, other data of a modulated data signal such as a carrier wave, or other transmission mechanisms, and includes information transmission media.

The above description of the present disclosure is provided for the purpose of illustration, and it will be understood by those skilled in the art that various changes and modifications may be made without changing the technical conception or essential features of the present disclosure. Thus, it is clear that the above-described embodiments are illustrative in all aspects and do not limit the present disclosure. For example, each component described as being of a single type can be implemented in a distributed manner. Likewise, components described as being distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

1.-19. (canceled)

1. A method for processing an audio signal, comprising:
receiving an audio signal including one or more object signals;
receiving information about positions of one or more preinstalled speakers;
arranging one or more virtual speakers based on the information about positions of the one or more preinstalled speakers; and
rendering the one or more object signals based on the one or more preinstalled speakers and the one or more virtual speakers.

2. The method for processing an audio signal according to claim 1, wherein the rendering comprises downmixing the one or more object signals to the one or more preinstalled speakers.

3. The method for processing an audio signal according to claim 2, wherein the downmixing is performed based on a Head Related Transfer Function (HRTF).

4. The method for processing an audio signal according to claim 1, wherein the audio signal further includes one or more channel signals which compose a 22.2-channel signal.

5. The method for processing an audio signal according to claim 1, the method further comprising:
decoding a QMF domain signal to output a Time domain signal.

6. A method for processing an audio signal, comprising:
receiving an audio signal including one or more object signals;
receiving information about positions of one or more preinstalled speakers;
identifying one or more reproduction-capable ranges based on the information about positions of the one or more preinstalled speakers;
arranging one or more virtual speakers to change a range which is not a reproduction-capable range into a reproduction-capable range; and
rendering the one or more object signals based on the one or more preinstalled speakers and the one or more virtual speakers.

7. The method for processing an audio signal according to claim 6, wherein the arranging the one or more virtual speakers is performed based on the information about positions of the one or more preinstalled speakers.

8. The method for processing an audio signal according to claim 6, wherein the reproduction-capable range is defined by three speakers selected from among the one or more preinstalled speakers and the one or more virtual speakers.

9. The method for processing an audio signal according to claim 8, wherein the rendering of an object signal included in a reproduction-capable range is performed based on VBAP (Vector Based Amplitude Panning) using three speakers defining the reproduction-capable range where the object signal is included.
